(19) United States
(12) Patent Application Publication
(10) Pub. No.: US 2002/0023478 A1
(43) Pub. Date: Feb. 28, 2002

(54) Measurement of car bodies and other large objects

(76) Inventor: Timothy Pryor, Windsor (CA)

Correspondence Address: LARSON & TAYLOR, PLC, 1199 NORTH FAIRFAX STREET, SUITE 900, ALEXANDRIA, VA, 22314, US

(21) Appl. No.: 09/939,729

(22) Filed: Aug. 28, 2001

Related U.S. Application Data
(60) Provisional application No. 60/228,109, filed on Aug. 28, 2000.

(51) Int. Cl. G01S 7/40

(52) U.S. Cl. 73/1.01

(57) ABSTRACT

The invention relates generally to the measurement of objects, and particularly large objects by sensory devices and their holding structures which may experience changes in position in the presence of varying ambient temperature conditions. It also relates to the set up and calibration of such devices, preferably using photo-grammetric systems in conjunction with the sensor data itself.

### CROSS REFERENCES TO RELATED CO-PENDING APPLICATIONS

U.S. Ser. Nos. 08/380,321 and 07/875,282 by the same inventor.

### FIELD OF THE INVENTION

The invention relates generally to the measurement of objects, and particularly large objects by sensory devices and their holding structures which may experience changes in position in the presence of varying ambient temperature conditions. It also relates to the set up and calibration of such devices, preferably using photo-grammetric systems in conjunction with the sensor data itself.

### BACKGROUND OF THE INVENTION

Temperature related variables have been a problem for years in the measurement of objects such as car parts. For example see Wachtler, U.S. Pat. No. 4,949,469, who was particularly concerned with axles. Recently temperature related issues have become a concern relative to the measurement of Car bodies and other large objects made in serial production, and typically prismatic in nature.

The temperature problem relates both the temperature of the object itself, and the effect of thermal expansion on the object, and to the effects of temperature on the structure used to perform the measurement. Typically such structures are comprised of CMM's, Robots having contact or vision sensors, or fixed frame like structures on which sensors, typically machine vision based, are mounted.

Representative examples of such devices including compensation for thermal and/or other parameters causing change which can influence such measurements of large objects are discussed in several references, such as:

PCT US/99/28413 by Markey et al published as publication WO00/34974.

Markey et al, U.S. Pat. No. 6,180,939.

Kim, U.S. Pat. No. 5,400,638.

Greer and Kim U.S. Pat. No. 6,078,846, also Greer and Kim published as WO 99/36216.

Kato U.S. Pat. No. 4,668,157.

Desmet PCT US/98/18559 published as WO 99/12082.

Graser, German application DE 198 21 873 A1 filed May 15, 1998 and published Nov. 25, 1999 (in German).

Examples which concern positioning and calibration variables in general are:

Pryor, U.S. Pat. No. 5,602,967.

Pryor U.S. Pat. No. 5,854,880, Target Based Determination Of Robot And Sensor Alignment.

In some of these examples a lookup table is created to determine the sensor reading on a fixed object as a function of the system temperature, for example during a daily excursion of temperature in a factory. In others, a thermal model of the system is made to allow its prediction based on temperature. And in others, a recalibration of a sensor, or robot carried sensor against one or more reference objects is used.

Typical sensors for measuring objects include triangulation types such as those disclosed in U.S. Pat. Nos. 5,734,172 or 4,645,348 and today made by the LMI Technologies or Perceptron companies. It is important to note however, that sensors of the triangulation type produced by LMI Technologies for car body measurements, are temperature corrected with respect to their performance. That is, the sensor readings stay constant over a temperature range if the object and sensor are in a constant relationship. If we assume such use of such sensor, then any variation in position recorded as a function of temperature or other effects, is due to only changes in the sensor support framework, or the body to be measured itself. It is believed that the sensors used by Markey et al of Perceptron are not of the temperature compensated type, and thus the experimentally corrected data technique of Markey is correcting both the sensor and the frame distortion, with respect to the body. And all three—frame, sensor, and body—can, and do, vary with temperature, so there is a problem of interrelationship of variables (that is to say, “Cross talk” ) except in the simplest cases it is believed.

### SUMMARY OF THE INVENTION

This invention is primarily concerned with the calibration of multi-sensor gage systems, either stand alone with their own fixture, or incorporated in to existing fixtures which may have other uses, such as assembly. Certain aspects of the instant invention however, may be used for robotic and other programmably positioned systems as well.

The invention comprehends the use of photo-grammetric datums which can be observed by either the sensors of the system, and/or external sensors, in order to determine temperature related and other information. This determination can be made during a calibration exercise, or even during normal operation. The invention provides a much more comprehensive correction for thermally induced distortion and accordant variation in data than does prior art methods, and is usable in many aspects of production, not just for sensory gage systems.

Datums used are located on any or all of:

One or more sensors;

The sensor mounting framework or brackets;

The tooling used to hold the object to be measured or worked (e.g. a car body);

The object itself;

The floor, pillars or other rigid structures in the vicinity; or

Other objects in the work area as desired.

Datums can be projected by the sensors on to an object, either a special test object or the object to be measured in production such as a car body

The above datums are observed by any or all of:

The sensors of the measuring system;

One or more sensor systems external and rigidly mounted;

One or more sensor systems external and flexibly or removably mounted; and

Sensors on the object to be measured or tooling associated with same.

External sensor systems can be Laser Tracker devices such as sold by Leica or SMX in the USA. However, I have found it preferable to use real-time photo-grammetry based systems such as that sold by Metronor, of Oslo, Norway (described also in U.S. Pat. Nos. 5,973,788; 5,805,287; 5,440,392; and 5,196,900 ). Such photo-grammetric systems have an advantage that they can interrogate multiple datums at once, are absolute in operation, and can determine not just the 3D coordinates (x, y, z) of a point on an object, but the angular relationships of an object in real time as well.

Suitable datums can be comprised of retro-reflectors, LEDs, contrasting markers, tooling balls, or any other suitable means known in the art. LEDs and retro-reflectors have proven to be most useful for fast accurate measurement in factory conditions. The former require low voltage power, the later require coaxial lighting with the camera axis of the photo-grammetric camera being used. A stereo pair thus generally needs two coaxial light sources which may be independently initialed with a camera read cycle.

### BRIEF DESCRIPTION OF THE DRAWINGS

FIG. 1a illustrates a conventional gage station for a car body as disclosed in the referenced patent applications. Also illustrated is the potential use of a thermal chamber to isolate as desired the station, and allow thermal cycling to occur.

FIG. 1b illustrates a thermal cycle undergone by the environment of the station during a workday.

FIG. 2 illustrates a typical photo-grammetric system based on a stereo camera pair, which is used to determine the location of an object such as a sensor in its field of view.

FIG. 3a illustrates a conventional car body gage station fitted with photo-grammetric camera systems of the invention used for determining datums on the sensors, object (in this case, a car), object holding tooling, framework, or surroundings of the station.

FIG. 3b illustrates the use of a photo-grammetric camera system in the station to observe sensors and landmark datums when the not obscured by the measured object.

FIG. 4 is a block diagram of operation of the preferred FIG. 3 Embodiment.

FIGS. 5a and 5c illustrate the connection of sensory data on opposite sides of the body and

FIGS. 5b and 5d graphically illustrate the range data obtained.

FIG. 6 illustrates the connection of sensory data on same side (or other surface) of the body.

FIG. 7 illustrates a robotically positionable sensor system calibration of the invention.

FIGS. 8a and 8b illustrate alternative embodiments for sensor projection of triangulation zones which can be measured by the photo-grammetric camera system.

### DESCRIPTION OF THE PREFERRED EMBODIMENTS OF THE INVENTION

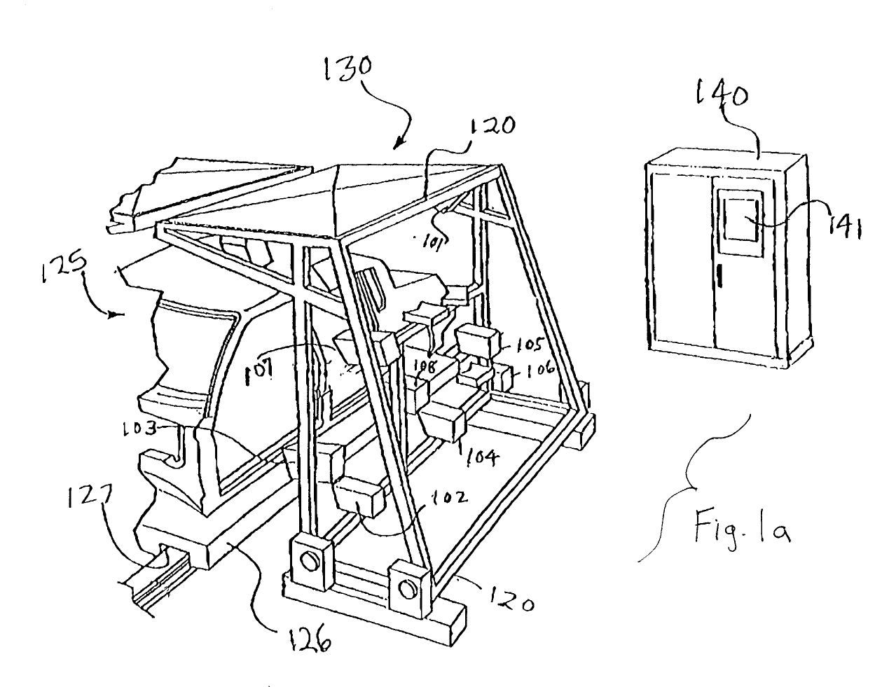

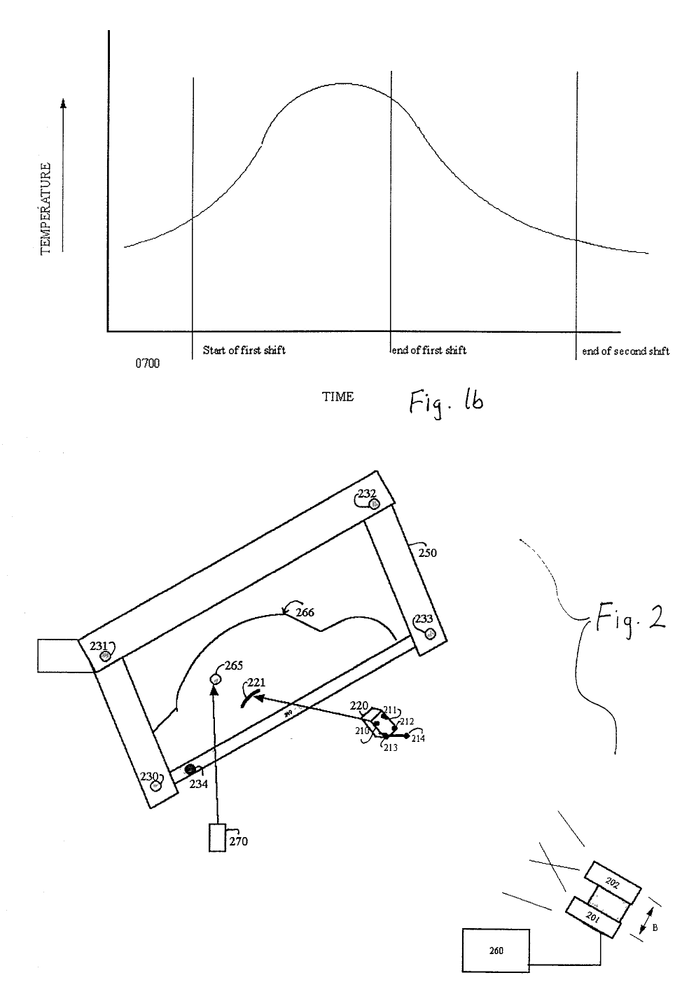

FIG. 1

FIG. 1a illustrates a conventional gage station for a car body as disclosed in the referenced patent applications. Only one side is shown for clarity, the other side is typically a mirror image.

As shown a plurality of vision sensors, typified by sensors 101-108, are located on frame 120 and used to measure locations of surfaces, edges, or holes of car body 125 on tooling 126 positioned by conveyor 127 in station 130. The sensors determine the location of surfaces of the body or features thereon such as holes with respect to the sensor, and are read by computer controller 140 with CRT display 141. The sensor operation is typically by triangulation and imaging as described for example in U.S. Pat. No. 5,734,172.

By calibrating the sensors with a known car body (or other measured part), and/or by setting the sensors in space using an external sensor system, accurate measurement of bodies can be made using the sensor data obtained, as has been described in the references above, and in U.S. Pat. No. 4,841,460 by Dewar et al. and U.S. Pat. No. 5,748,505 by Greer. These references however, do not describe a means by which sensors can be easily kept calibrated in daily production, including the effects of temperature, which may change the pointing direction of the sensors such as 101-108, altering the data obtained when complex 3D surfaces (such as those of car bodies) are measured, whose distance from the sensor can change greatly when small pointing direction fluctuations occur.

FIG. 1b illustrates a thermal cycle undergone by the environment of the station during a work day which typically is two shifts, 8 hours each. Unless the plant is air conditioned, the structure and the object to be measured, such as a car body, heat up during the day and then begin cooling down at night. Depending on location, swings can be 15 degrees Centigrade or more. The structure holding the sensors (and in the robot case discussed, moving the sensors as well), and the object to be measured both expand with increasing temperature, and then contract as cool down occurs. But the expansion and contraction occurs in different ways, given the complexity of the structures in each case. Thus the position of the individual sensors and their pointing direction varies, with respect to the body, causing readings which vary with temperature.

Some users wish to turn the sensor equipped gage frame itself into a standard reference, replacing the use of CMM's (Coordinate Measuring Machines) in special thermally controlled rooms for this purpose. To do this, the sensed data from the sensors, including their frame must be known absolutely in 3D space on the production line, day in and day out. This is quite different than the historic use of such in-line “vision” gages as a comparator—from one part (or a group) to the next. And it is more rigorous than the occasional comparison of inline data to a CMM checked body which is then used to up-date the calibration. (noting too, that if one is eliminate the CMM and its cost, both physical and labor related, that one has to have some alternative calibration method traceable to known standards of consequence.)

There are at least two issues. The first is the initial absolute set up of the sensors, and particularly the measured points, in an absolute reference coordinate system. The second issue is the drift in such a set up with temperature or other variables present in the factory.

Regarding the latter, and particularly the temperature aspect, a procedure has been described by Markey et al in the published PCT application referenced above whereby a reference body is placed in the station and left there in a fixed position. Ambient temperature of the system is monitored throughout a day or other excursion of temperature and data from each sensor taken from the body is monitored and stored in a table along with the temperature. (one can alternatively, just store the deviation from some nominal sensor reading ). Then at some future time, on some instant part to be checked, all that is then needed to correct the sensor data, is to check the temperature and implement the correction from the table.

Markey et al also describe correction of the readings for the temperature of the part, which is a well known issue in the measuring world. Part temperature variation however, is not a major problem in most plants where the gage station is generally distant in time, space, or both from heat inducing operations.

The Markey et al invention has merit, but treats only one sensor as an individual entity, and does not account for the over all distortion of the structure or the change in juxtaposition of the sensor to the absolute reference system first Established. Thus it is useful primarily to improve readings of the largest outliers caused by temperature excursion. In addition, where major change occurs, the possibility of added uncertainty due to object differences, and object position differences influences the calibration data, which is unaccounted for in their invention.

What this instant invention discloses, is a method to achieve a higher degree of accuracy than heretofore possible, in particular by utilizing a higher degree of initial monitoring of positional issues as a function of temperature, and by introducing the concept of continuous monitoring of same. The later step also allows correction and alerts for random events, as well as structural drift due to other non-temperature causes.

Other aspects of the instant invention disclose use of systems which can make the thermal compensation independent of availability of a reference work piece, which in the early stages of design and tooling is often difficult to obtain. If such a reference piece isn't a good example, the compensation can be suspect due to the assumptions made in a Markey type arrangement.

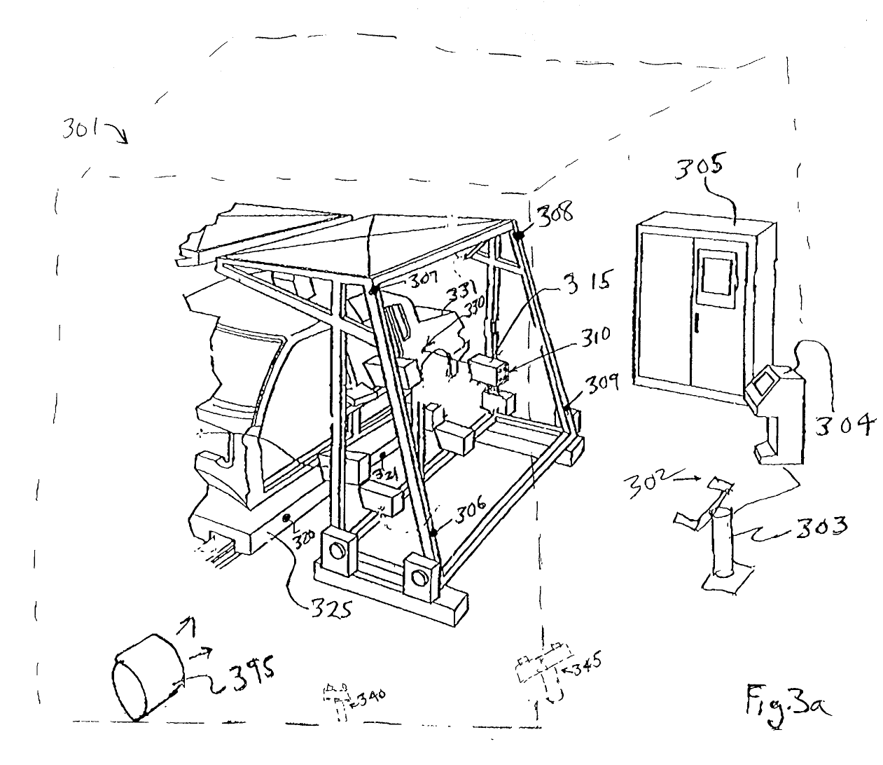

FIG. 2

FIG. 2 illustrates a typical photo-grammetric system based on a stereo camera pair, which is used to determine the location of an object such as a sensor in its field of view. As shown, a photo-grammetric system comprised of a stereo pair (or more) of cameras 201 and 202 spaced apart by a baseline “B”, observe datums 210-213 on an object 220, such as a sensor for example. By comparison of the images of the datums in each camera field, the position and orientation of object 220 in 6 degrees of freedom can be determined (x, y, z, roll, pitch, and yaw) relative to the photo-grammetric system.

The cameras can at one and the same time also observe datums 230-234 which can be on objects in the vicinity, such as frame 250, or a pallet. Such (data can be taken instantaneously (limited only by the integration time of the cameras or strobe time, if strobed sources used), and interrelationships of objects (e.g. sensor position with respect to the frame) developed using the data, via suitable software for example in analysis computer 260, which may be the same as computer controller 140, if desired.

Angular resolution of object 220 is improved by making the spacing of points 210-213 as large as practicable, and by having a large camera spacing base-line B. However, the larger B, in general, the smaller the field over overlap of the two cameras, and thus the field of view of the camera system. Angular resolution can also be improved by having one or more of datums 210-213 not in the plane of the others—for example as shown by stand-off datum 214.

It should also be noted that projected datums on an object are observed with a photo-grammetric camera system, in addition to any other datums desired. This combined system can actually measure the location of the projected sensor point in two ways. For example laser spot 265 on object 266 projected by laser 270 can also be detected. This spot can be generated with a hand held pointer, a programmable projector, or it can be a zone such as the line 221 projected by a sensor such as object 220. In this latter case, the photo-grammetric system measures the location of object 266 (e.g. a car body) relative to an absolute base at potentially lower resolution, and with the sensor 220 measures at higher resolution relative to the sensor system and the framework holding same.

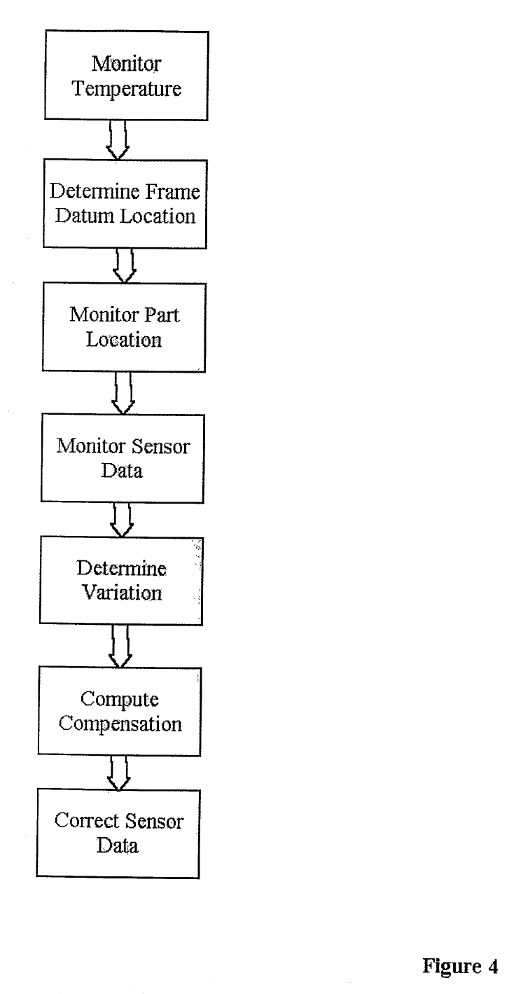

By monitoring the variation with temperature or other perturbation of position of the projected datums from the sensor, a degree of correction of the sensory data can be determined, as sensor source pointing direction variation is a major cause of sensor error in measurement of object location with respect to it. This is discussed further relative to FIG. 4

More than one laser spot or other datum such as 265 can be projected on the object, and monitored in its 3D location by the photo-grammetric system of the invention.

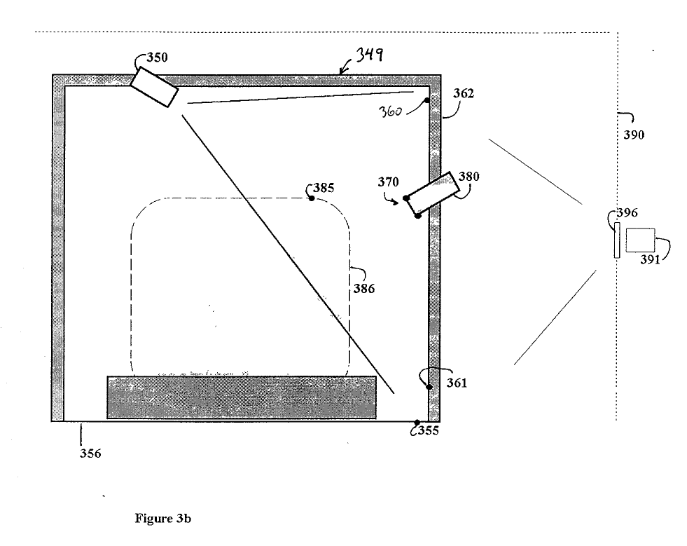

FIG. 3

FIG. 3a illustrates such a conventional station fitted with photo-grammetric camera systems of the invention used for determining datums on the sensors, object, object holding tooling, or framework of the station.

As shown the station 301 of the type shown in FIG. 1 is monitored with real time photo-grammetric camera system 302, in this case mounted fixedly on a pillar 303, and readout by computer 304 (which may alternatively be incorporated into that of the station computer 305.

This system illustrated has a field of view of 6 meters, encompassing the sensor holding framework, with resolution to adequately determine (e.g. to 0.1 mm, or one part in 60,000) the location of points such as 306-309 on the overall frame structure, point set 310 (similar to 211-213 of sensor 220) on an individual sensor 315, points 320 and 321 on the conveyor pallet 325 holding the body 331, and, ii not obscured by the sensor and framework hardware, point or other zone 330 for example projected on the body or other object 331 to be measured by the laser projector included in triangulation based sensor 315 (or a separate laser source if desired).

The photo-grammetric system can alternatively be movably mounted so as to view the frame and sensors from other vantage points, such as locations 340 and 345 (dotted lines), increasing accuracy and avoiding obscuration. It is also possible to use more than one photo-grammetric system fixedly positioned at each location to achieve the same task, with all data coordinated by a central readout computer such as computer 304.

Data can be taken from this photo-grammetric system, for example, to perform as desired, any or all of the following functions:

Determine the movement of the sensors and/or the distortion of the whole frame, as a including the sensors mounted thereon as a function of temperature during actual operation over one or more thermal cycles (e.g. days). This data can be then used to update the absolute calibration made of sensor location, or sensor measuring point location.

Experimentally determine said sensor location or frame distortion relative to landmarks such as fixed points on the floor, pallets or frame during actual operation over one or more thermal cycles (e.g. days). This too can be as a function of temperature measured. And at any time in the future a landmark correction can be used to correct the whole matrix of sensor data.

Determine the above in conjunction with cycling the object in temperature along with the frame and station.

FIG. 3b illustrates the use of a photo-grammetric camera system alternatively itself mounted on the framework 349 of a gage station, and used to observe the sensors of the station located on the opposite side—in some cases, when the object is not present (if necessary to avoid obscuration).

As shown the camera system 350 observes the datum 355 in the floor 356, as well as datums 360 and 361 on the frame 362, and datum set 370 (similar to 310, for example) on the front of sensor 380 attached to the frame 362. Other datums on other parts of the floor, or frame, or other sensors can also be observed.

In addition, a known reference datum 385 on a reference body such as body 386 dotted lines inserted into the station for calibration purposes can also be observed. Typically such a reference body is known with respect to the frame, such that the theoretical position of point 385 can be calculated with respect to the sensor. This can also be done with actual test bodies. Deviation from the position as predicted can be stored as an offset in computer 304.

Also illustrated in dotted lines in FIG. 3b is the potential use of a thermal chamber 390 to isolate as desired the station, and allow thermal cycling to occur, which may be augmented by introduction of heat or cooling to cause a large excursion of temperature to occur- also perhaps in a shorter time frame.

Further illustrated in FIG. 3a is the use of at least one fan 395 to move air in a steady flow past the station.

Note that the external photo-grammetric camera system of the invention such as camera system 391 (similar to 302, in FIG. 3a) can be located outside the thermal chamber if desired, via provision of window 396.

The invention as in FIG. 3 comprehends determining at least some positional relationships at all times, in order to compensate the sensor readings in real time, or to determine a series of readings of points over a thermal or other distortional Cycle of the system and use this data to compensate at a future time the sensor readings taken (even if the photo-grammetric system is no longer present).

FIG. 4

FIG. 4 is a block diagram of one mode of operation of the apparatus of FIG. 3.

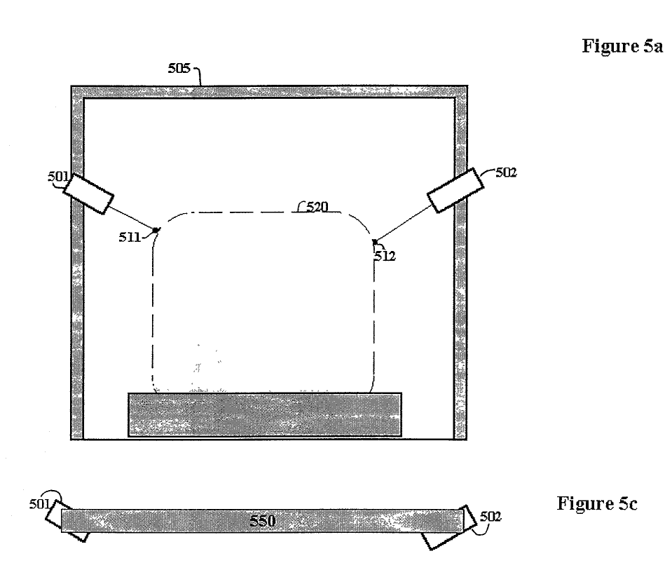

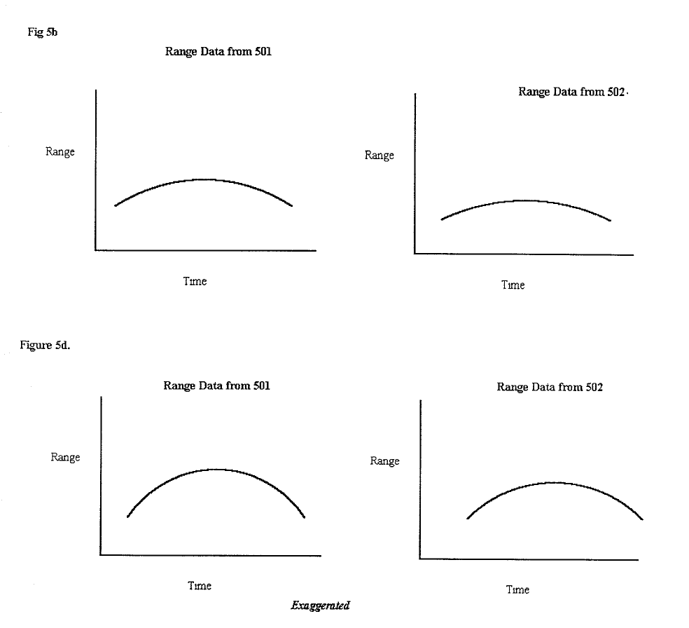

FIG. 5

FIG. 5a diagrammatically illustrates the connection of sensory data on opposite sides of the body, which can be used to improve the performance of the instant invention or, alternatively, a Markey et al device.

Consider sensors 501 and 502 of the temperature compensated LMI type connected to framework 505 and monitoring points 511 and 512 on body 520. By coupling data from opposite sides of the body, and framework, the performance of the total structure of each can be ascertained including differences in the degrees of thermal expansion of each.

For example consider in FIG. 5b, the range data from sensors 501 and 502 as a function of time (for the same ambient temperature curve as illustrated in FIG. 1b). As is clear, the data from sensors 501 and 502 follow the same general relation indicating a difference in thermal expansion of the body with respect to the frame. But that from sensor 501 exhibits more than twice the temperature related effect of the data from sensor 502, indicative of a general lean of the body (at the cross section of the body represented in the plane of the diagram), of the frame work relative to the body, since the differential of the two sensors is nearly constant (indicated of only a small differential thermal growth in body width relative to frame spacing at that section). The frame is also expanding at a higher rate than the body.

Another useful embodiment is to couple the sensors in a certain direction using an invar bar (or a bar made of another material having very low thermal coefficient of expansion), such as 550 shown in FIG. 5c, used to position 501 with respect to 502 in the cross-car dimension, thereby making all change due body effects only (if the bar is positioned independent of the frame). The respective sensor readings are now larger with respect to temperature, as shown in FIG. 5d, since the sensor position no longer varies appreciably with temperature.

In this manner, the body cross car change with temperature can be measured. The bar can then be anchored to one side of the frame, and free to move on the other. In this case, the frame bending or other positional variation can be determined with respect to the now known cross car dimensional change with temperature.

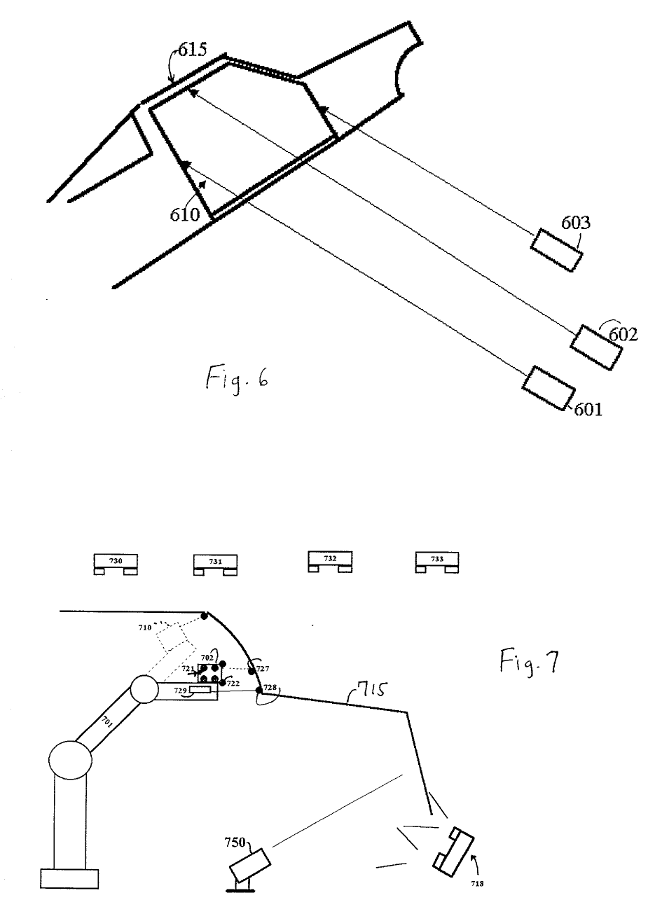

Similarly, other groups of sensors such as those fore and aft (e.g. hood and trunk) or around door openings (such as shown in FIG. 6) can be similarly compared with temperature to develop information concerning other portions of the frame, as well as the body as a function of temperature.

This data can also be compared to other sections taken by sensors spaced along the length or width of the body.

FIG. 6

FIG. 6 illustrates the connection of sensory data on same side (or other surface) of the body. For example consider sensors 601-603 each monitoring a position of an edge point on a door opening 610 on one side of body 615. The sensors are attached to a frame structure not shown for clarity.

In one version, the group of temperature corrected range sensors is read at one instant of time during a thermal cycle on a reference body, such as the cycle of FIG. 1b. Data taken from the sensors at that instant is used to solve for a correction plane established by the points on the door opening determined by the group of sensors on the one side of the body. And this plane is then compared to individual readings from each sensor as a function of the temperature experienced during the cycle, Thus isolating individual sensor readings from body influences which could vary from body to body and affect calibration. Readings of sensors relative to the established plane or other multipoint reference criteria desired, are then stored and correlated in time relative to temperature which is measured in the area of the sensors over a thermal cycle.

The data from “N” sensors taken as described in FIG. 5 and 6 can also predict the frame function at a large number of positions, from which frame undulation as a function of temperature can be modeled accurately.

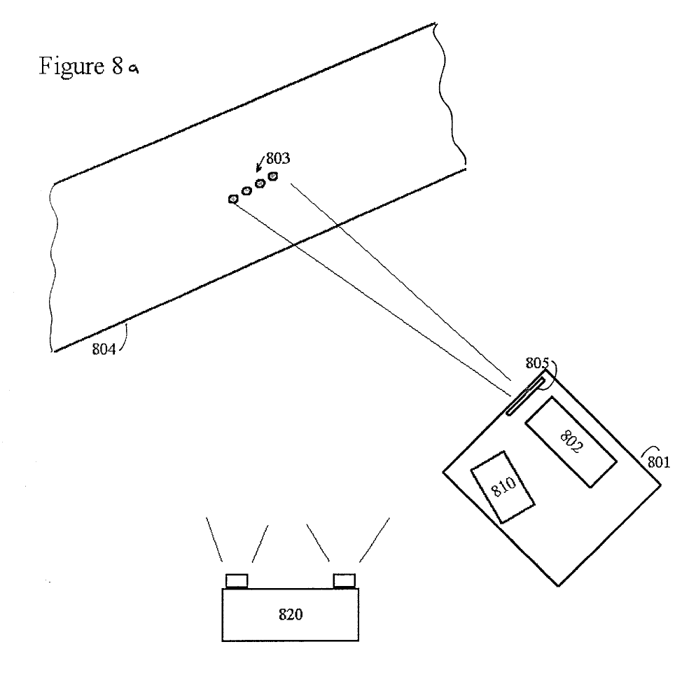

FIG. 7

FIG. 7 illustrates a robotically positionable sensor system calibration of the invention in which the robot 701 moves sensor 702 to a succession of positions such as that shown, or 710 (dotted lines) with respect to body 715 in order to determine dimensions or location of the body. In this case the robot typically puts the sensor in essentially the same position as the much larger plurality of sensors would be in on the fixed frame of FIGS. 1 or 3. Large savings are possible as only one sensor now can do the work of many, with the frame cost in part offsetting the robot cost. (though typically for a body, two robots, one on each side are typically required, and sometimes four).

The biggest robot advantage however, is flexibility—to position sensors according to a program, which can be changed to suit different measuring regimens, and most importantly,—also to accommodate different bodies made on the same line-increasingly a requirement.

The problem hereto fore with this approach has been robot positioning accuracy, and particularly variations in position caused by temperature effects. These effects are magnified in the robot case, because of the heat contribution of the robot motors and other electrical devices, though if the system is never turned off, and exercised periodically such effects tend to normalize.

In the invention herein, a photo-grammetric system 718 similar to system 302 can be used to determine robot locations, and the sensor projected datums on the object, just as taught in the above figures relative to fixed sensors. This can be done in a calibration mode, or in continually in actual production.

For example, data can be taken of sensor position using LED target set 721 (composed typically of 34 target datums as described above, for example in FIG. 2) and other sets if required, such as set 722 facing in other directions as needed, having known positional relationships to the sensor axis as well. Data from one or more of these sets, or other suitable datums representative of sensor position, allows the system 718 to determine in six axes the sensor position at any desired time. If desired the laser spot 727 (or other zone such as a line ) projected by the sensor or spot 728 (or other zone such as a line ) projected by auxiliary laser 729 can also be seer on the measured object by system 718 as taught above . As the robot moves, both in its normal excursion to reach the measurement points on the body or other object desired, and as a function of temperature through a temperature cycle, data concerning sensor location in up to 6 axes is taken and a calibration matrix developed with respect to the robots sensor positioning performance. At a future time, the temperature measured in the work area is used with the calibration matrix and the robot joint position information to provide a lookup of correction data.

As pointed out, this can also be done in real time, with the photogrammetric sensor system either always on, or energized say every ten work cycles. In the continuous mode, there is no need per se to measure temperature, as the position in space is always being corrected by the absolute photo-grammetric system (which may be itself however influenced by temperature, another issue and dependent on its mechanical construction, noting however that the camera baseline and lens mountings can be of invar if desired to prevent thermal growth).

To make corrections according to the invention, a production system may desirably employ a large number of relatively simple photo-grammetric stereo camera systems are often required (as opposed to one system such as 718), shown as boxes 730-733 on one side of the work area. With 4 or 5 such camera sets, the whole work area comprising the critical side of the body and the top, front and rear portions near the sides can be covered without obscuration, and with sufficient accuracy. These photo-grammetric cameras can be positioned in other locations than directly overhead as well.

Finally, it is noted that the photo-grammetric cameras can observe not only the robot carried sensor position and orientation, but that of any auxiliary fixed sensors such 750 which can be used for example to check points on the body difficult to reach by the robot or to see locations of holes or other body features used to establish the coordinate system of the body. The photo-grammetric system desirably sees the robot and the fixed sensors, and possibly any tooling datum's desired as well, all in the same coordinate system, which in turn can be related to the car body coordinate system by known transformations via computer system connected to the robot, and the photo-grammetric and other sensors.

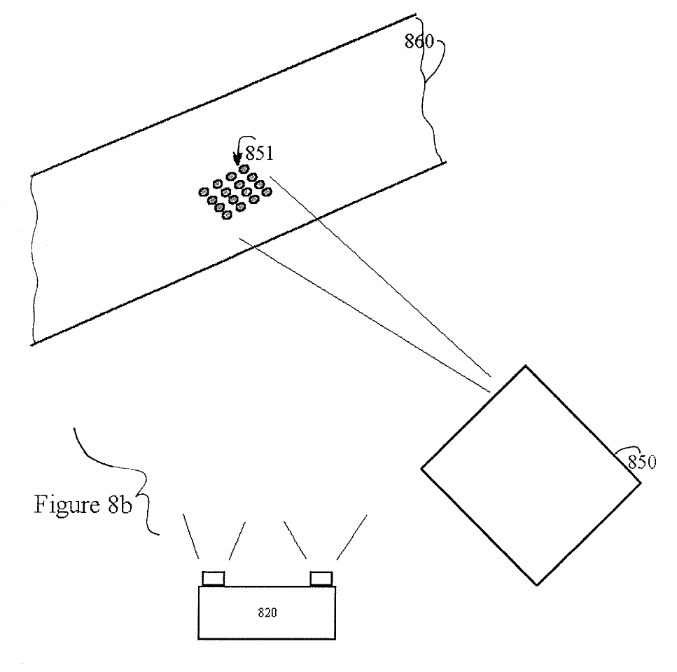

FIG. 8

FIGS. 8 illustrates alternative embodiments for sensor projection of triangulation zones which can be measured by the photo-grammetric camera system.

FIG. 8a illustrates the use of a sensor 801 having laser 802 projecting a line of points 803 on object 804 via a holographic grating 805. Each point of set 803 can be determined as desired in its location in 3D space by photo-grammetric sensor system 820, imaging said points as discussed in FIG. 2. The sensor 801 also images and determines the location of the points relative to itself via camera 810, via triaingulation. This allows the sensor to be calibrated in its position both statically and as a function of temperature induced frame distortion, sensor drift, or object change with temperature. The spots can be coded as to which is which, or manually isolated to allow both the sensor and the photo-grammetric system to determine their inter-relationships relative to the spot chosen.

Its noted that as taught in U.S. Pat. No. 5,734,172 that if known spot projected spacings 801 are used, that the angular relationship in one plane of the sensor to the body surface can be determined by the sensor. Variation in this relationship as a function of temperature and part can thus be monitored.

FIG. 8b illustrates the use of a sensor 850 like 801 but in this case projecting a grid of points 851 onto object 860 in order to determine the angles of the sensor axis with respect to the object in two planes, as well as points on the body surface produced by a single line of points (and the angular orientation of the sensor in the plane of the line).

The above described spot, row, and grid type projection devices may also be used independently with the photo-grammetric system alone.

While the best mode for carrying out the invention has been described, those familiar with the art to which this invention relates will recognize various alternative designs and embodiments for practicing the invention as defined by the following claims.

What is claimed is:

1. A method for compensation of sensor readings for effects caused by thermal distortion in a structure, comprising the steps of:
providing a structure, including a plurality of optical sensors attached thereto, said sensors used to determine the location or dimension of an object.;
determining the position of a plurality of points of said structure under a cycle of temperature at a plurality of points; and
using said determined positions, compensating the reading of at least one of said sensors.

2. A method according to claim 1, wherein said determining step is achieved electro-optically.

3. A method according to claim 1, wherein said determining step is performed at a number of times in a temperature cycle of said structure.

4. A method according to claim 1, wherein said determining step is performed substantially at the same time said sensors are used to read said object location or dimension.

5. A method according to claim 2, wherein said electro-optical determination is made using photogrammetry.

6. A method according to claim 2, including the further step of determining the location of at least one projected zone of light on said object.

7. A method according to claim 1, wherein at least two of said sensors are connected by a member having substantially zero thermal co-efficient of expansion.

8. A method according to claim 1, wherein data from at least two of said sensors on opposite sides of said object are compared.

9. A method according to claim 1, wherein data from at least two of said sensors on opposite sides of an opening in said object are compared.

10. A method for compensation of sensor readings, comprising the steps of:
providing a structure, including at least one optical sensor attached thereto, said at least one sensor used to determine the location or dimension of an object;
determining the position of a plurality of points of said structure during a measurement cycle for determining the location of dimension of said object; and
using said determined positions, compensating the reading of said at least one sensor.

11. A method according to claim 10, wherein the structure is a frame having a plurality of sensors attached thereto.

12. A method according to claim 10, wherein the structure is a robot which can position one or more sensors sequentially at different positions with respect to said object.

13. A method according to claim 10, wherein said determining step is achieved electro-optically.

14. A method according to claim 10, wherein said determining step is used to compensate sensory readings for temperature effects.

15. A method according to claim 13, wherein said electro-optical determination is made using photogrammetry.

16. A method according to claim 10, including the further step of determining the location of at least one projected zone of light on said object.

17. A method according to claim 10, wherein there are at least two of said sensors which are connected by a member having substantially zero thermal co-efficient of expansion.

18. A method according to claim 10, wherein data from at least two of said sensors on opposite sides of said object are compared.

19. A method according to claim 10, wherein data from at least two of said sensors on opposite sides of an opening in said object are compared.

20. A method according to claim 12, including the additional step determining the location of fixed sensors in addition to robot carried sensors.

21. A method according to claim 14, wherein said effects include those caused by change of said structure with temperature.

22. A method according to claim 10, including the additional step of determining position of at least one point on a member holding or conveying said object.

23. A method according to claim 10, including the additional step of determining position of at least one fixed point not on said object.

24. A method according to claim 10, including the additional step of determining position of at least one point on said object.

25. A method according to claim 10, wherein said sensors are electro-optical.

26. A method according to claim 25, wherein said sensors are based on laser triangulation.

27. A method according to claim 1, including the additional step of determining position of at least one point on a member holding or conveying said object.

28. A method according to claim 1, including the additional step of determining position of at least one fixed point not on said object.

29. A method according to claim 1, including the additional step of determining position of at least one point on said object.

30. A method according to claim 1, wherein said sensors are electro-optical.

31. A method according to claim 30, wherein said sensors are based on laser triangulation.
